(19) United States
(12) Patent Application Publication
(10) Pub. No.: US 2026/0161719 A1
(43) Pub. Date: Jun. 11, 2026

(54) Artificial Intelligence (AI) Agent Recommendation System

(71) Applicant: Google LLC, Mountain View, CA (US)

(72) Inventors: Bhavika Goyal, Redwood City, CA (US); Senthil Kumar Hariramasamy, Mountain View, CA (US); Rushil Grover, San Jose, CA (US)

(21) Appl. No.: 19/410,841

(22) Filed: Dec. 5, 2025

Related U.S. Application Data
(60) Provisional application No. 63/728,569, filed on Dec. 5, 2024.

(51) Int. Cl. G06F 16/9535; G06F 16/9538

(52) U.S. Cl. CPC G06F 16/9535; G06F 16/9538

(57) ABSTRACT

Systems and methods for the generation of a recommendation using a machine-learned model. The method can include receiving, from a client device, a user query. Additionally, the method can include determining, using a machine-learned model operating on a computing system, an input tool based on the user query. Moreover, the method can include receiving, from the client device, additional information, the additional information being uploaded using the input tool. Furthermore, the method can include processing, by the machine-learned model, the user query and the additional information to select a content item associated with a content provider. Subsequently, the method can include presenting the content item on a graphical user interface.

### FIELD

The present disclosure relates generally to systems and methods for presenting a recommendation for a content item that is generated by a machine-learned model.

### BACKGROUND

Content providers (e.g., advertisers) spend significant resources and effort to drive user traffic to their online stores. However, based on industry benchmarks the average conversion rate for a content item (e.g., advertisement) is low (e.g., below 5%). One of the causes of the low conversion rate is lack of an immediate and personalized assistance similar to a recommendation from a knowledgeable salesperson in a physical store. For example, once a user is on a website, the user is often left to navigate, find, and compare products and information by themselves. However, new AI capabilities have the potential to transform e-commerce into a more assisted and helpful experience, thus leading to a better user experience and higher conversion rates.

### SUMMARY

Aspects and advantages of embodiments of the present disclosure will be set forth in part in the following description, or can be learned from the description, or can be learned through practice of the embodiments.

According to one embodiment, the present disclosure provides for a method for generating a recommendation. The method can include receiving, from a client device, a user query. Additionally, the method can include determining, using a machine-learned model operating on a computing system, an input tool based on the user query. Moreover, the method can include receiving, from the client device, additional information, the additional information being uploaded using the input tool. Furthermore, the method can include processing, by the machine-learned model, the user query and the additional information to select a content item associated with a content provider. Subsequently, the method can include presenting the content item on a graphical user interface.

According to another embodiment, the present disclosure provides for one or more exemplary non-transitory computer-readable media storing instructions that are executable by one or more processors to cause a computing system to perform the methods described herein.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is an exemplary block diagram of a system for the generation of a comparative data structure using a large language model in accordance with embodiments of the present disclosure;

FIG. 2 is an exemplary graphical user interface of a system in accordance with embodiments of the present disclosure;

FIG. 3 is an exemplary embodiment of a graphical user interface of a system in accordance with embodiments of the present disclosure;

FIG. 4 is an exemplary diagram of a use case in accordance with embodiments of the present disclosure;

FIG. 5A is a flow chart diagram illustrating an example method according to example implementations of aspects of the present disclosure;

FIG. 5B is a flow chart diagram illustrating an example method for training a machine-learned model according to example implementations of aspects of the present disclosure;

FIG. 6 is a block diagram of an example processing flow for using machine-learned model(s) to process input(s) to generate output(s) according to example implementations of aspects of the present disclosure;

FIG. 7 is a block diagram of an example sequence processing model according to example implementations of aspects of the present disclosure;

FIG. 8 is a block diagram of an example technique for populating an example input sequence for processing by a sequence processing model according to example implementations of aspects of the present disclosure; and

FIG. 9 is a block diagram of an example networked computing system according to example implementations of aspects of the present disclosure.

### DETAILED DESCRIPTION

The present disclosure is generally directed to a system that transforms standard e-commerce interactions into a personalized, assisted experience using a multi-modal Artificial Intelligence (AI) agent. Traditionally, users navigating online stores are left to find and compare products on their own, often resulting in low conversion rates due to a lack of guidance comparable to a knowledgeable salesperson in a physical store. The described system bridges this gap by providing an AI-powered interface that guides users through complex decision-making processes, offering immediate, context-aware assistance that helps better articulate user needs.

A core capability of the system is the dynamic selection of input tools or modalities based on the user's specific query and intent. Unlike static chatbots that rely solely on text, the machine-learned models described herein can determine the most effective way to gather information (e.g., by asking the user to upload an image of a room, participate in a quiz, or upload a video for diagnostic purposes). For instance, if a user searches for furniture, the system may automatically present an image upload tool to visualize a rug in their living room.

To facilitate this experience across diverse verticals, the system provides a self-service platform for content providers (e.g., advertisers) to generate customized AI agents without extensive technical overhead. By inputting high-level domain information, specific agent objectives, and brand constraints (such as excluded words or competitor names), the system utilizes a generative architecture (e.g., a prompt-to-prompt model) to construct the agent's behavior. This allows providers to rapidly deploy agents that speak in their brand voice and recommend their specific inventory while maintaining strict adherence to business rules.

Once the user interacts with the selected input tool, the system processes the multi-modal data (e.g., such as analyzing the spatial dimensions in an uploaded photo or the symptoms in a repair video) to perform precise offer matching. The AI agent goes beyond simple keyword matching by understanding the context of the user's situation, such as identifying movable items for storage or assessing the aesthetic style of a room. This deep understanding enables the system to recommend specific content items (e.g., products or services) that are technically aligned with the user's constraints and the provider's available inventory.

The system can be designed to minimize dead-ends in conversation and build user confidence through rich explanations and visualizations. By proactively suggesting next steps and explaining why a specific recommendation was made (e.g., explaining that a specific tool is required because a video showed a specific blinking light on a machine), the AI agent acts as a companion rather than just a search engine. This results in a frictionless journey where the user feels supported, leading to more qualified leads for the content provider and a more satisfying decision-making process for the user.

According to some embodiments, the present disclosure is directed at a system with a multi-modal AI agent that provides personalized recommendations. The system can guide users towards recommended products, like a customer representative. The AI agent can provide an assisted experience by using a large-language model (LLM) to drive the conversation and performing an analysis to make a recommendation. The system can provide multi-modal interactive experiences, help better articulate user needs and provide inputs in a frictionless manner. Additionally, the AI agent can provide personalized recommendations based on past searches and agent interactions, with rich explanations and product visualizations for confident decision making. Moreover, the AI agent can provide multi-turn conversation with ability to answer user initiated free form questions either via text or voice.

In some embodiments, the system can include a dynamic agent that has been fine-tuned by a content provider. This enables easy deployment for opted-in content providers, with minimal input by the content provider. Additionally, this can be built on top of existing AI technologies and target a variety of use cases. The system can provide AI-powered recommendations that are available for all content providers for supported use cases.

Additionally, the AI mediated interactions can assist users interact with content providers in a rich and natural way, like a customer representative. These new interactions help content providers better match their offerings to user needs, generating an improvement in performance (e.g., conversion rate).

According to some embodiments, the AI agent page can exist as a URL. A user can visit the agent and provide their web browser history. The user can bookmark the agent in their browser and share the agent with a friend. The user can access the agent from other features on a platform. Moreover, the content providers can directly link the agent to their site.

The system can dramatically accelerate user journey and deliver more qualified leads to content providers by connecting users and content providers through rich experiences, like customer representative. The LLM can make the recommendation with minimal user input, thus enabling a better user experience. The LLM can drive the conversation and suggest actions, next steps versus expecting the user to initiate an interaction to minimize dead-ends in the conversations. Additionally, the system can leverage multimodal inputs (e.g., image, audio, video) and intuitive interaction patterns (such as checkboxes, inline editing), reducing user friction

Additionally, the system can be user oriented with the proper controls. The system can empower users to provide feedback and corrections, ensuring continuous improvement and personalized output. The system can provide transparent source attribution. For example, the system can attribute the data and experience to a specific content provider.

Moreover, the system can be authentic to content provider business and drive value. In some instances, the system can recommend products and services that align with the business and offerings of the content provider. The system can generate recommendations and content items only based on content present on the domain of the content provider and/or assets (e.g., text, images, feeds, video) provided by the content provider. The content items can generate long-term value for the content provider (e.g., improved performance, higher conversion rate) and help accomplish objectives of the content provider.

The system can include a multi-modal agent, which can guide users towards recommended products. The system can parse the user input. The user input can be multi-modal. Additionally, the system can ask a free form chat questions. Moreover, the voice of the system can be a companion. The multi-modal interactive experiences enable a user to better articulate user needs and provide inputs in a frictionless manner. The recommendation generated by the system can be a personalized recommendation based on past searches and agent interactions. The recommendation can include detailed explanations and product visualizations for confident decision making. The system allows multi-turn conversation with ability to answer user initiated free form questions either via text or voice.

The technology of the present disclosure represents a significant advancement over existing comparison tools by leveraging the LLM to systematically refine and present personalized recommendations. Unlike conventional tools, this approach utilizes the LLM to categorize and filter user queries based on specific user interest, thereby enhancing the relevance and context. Additionally, the integration of data processing techniques such as normalization, ranking, and grounding ensures that attributes are standardized and prioritized, leading to a more accurate and user-friendly comparison. This methodology results in a more generalized and contextually relevant overview of products representing an improvement over existing comparison tools.

Technical effects of the disclosed methodology include the automated scalability of complex AI agents across disparate technical domains. By utilizing a prompt-to-prompt generation architecture, the system eliminates the need for manual, hard-coded logic for each new vertical. The system ingests unstructured high-level objectives and programmatic constraints to synthetically generate the precise system instructions required for the runtime model. This significantly reduces the computational resources and development time required to deploy domain-specific agents, allowing a single underlying architecture to service technically distinct use cases, such as visual spatial analysis for storage logistics versus diagnostic video analysis for mechanical repairs.

Further technical benefits are realized through the system's ability to normalize and rank unstructured multi-modal inputs to improve query relevance. Conventional comparison tools often struggle with dead-ends where a user's text query is insufficient to filter a large database effectively. The present system overcomes this by dynamically triggering specific input tools (e.g., a camera) that force a higher-fidelity input signal. The system then processes this input (e.g., extracting a specific error code sequence from a video of a blinking machine light) to rigorously filter the content provider's database. This results in a more efficient search traversal, reducing the number of interaction turns required to reach a correct result and minimizing the retrieval of irrelevant data packets.

Additionally, the system provides a mechanism for continuous refinement and fine-tuning of the agent's decision logic through a simulated preview environment. The architecture allows for the immediate simulation of the generated agent, enabling the content provider to iteratively adjust the agent brief based on real-time feedback. This feedback loop updates the underlying prompt generation model, ensuring that the deployed agent's responses and its usage of specific modalities are optimized for accuracy before live deployment. This reduces the likelihood of hallucinations or irrelevant tool usage during runtime, thereby preserving processing power and ensuring a coherent user experience.

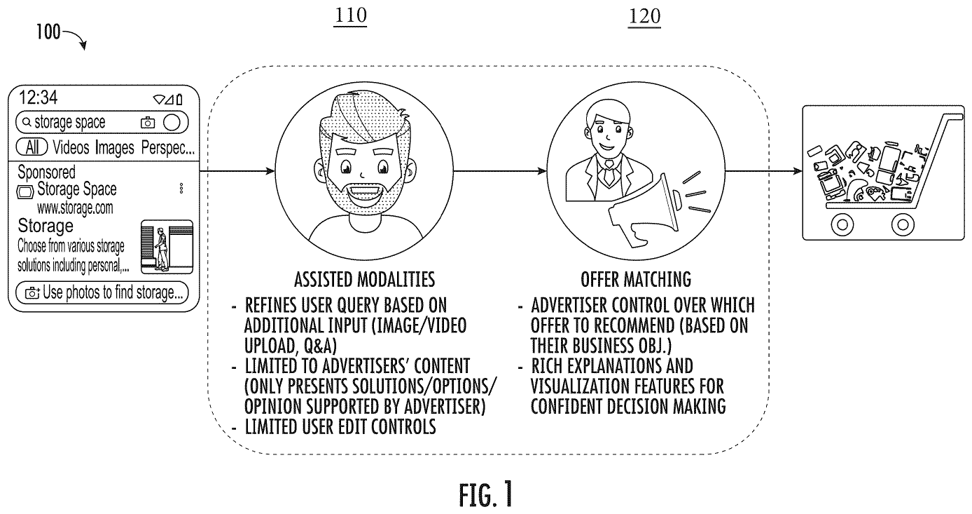

FIG. 1 is an exemplary block diagram of a system 100 for the generation of a recommendation using a large language model in accordance with embodiments of the present disclosure. The system 100 generally illustrates the flow of data from a user's initial interaction to a final recommended output, facilitated by distinct processing modules.

The system 100 can include an input parsing module 110 (labeled as “Assisted Modalities” in FIG. 1) and an offer matching module 120 (labeled as “Offer Matching” in FIG. 1).

The process begins with the input parsing module 110 receiving a user query from a client device (e.g., “storage space” as shown in the exemplary interface). The input parsing module 110 is configured to refine the user query by determining and deploying a specific input tool (or modality) best suited to articulate the user's specific intent. As illustrated, the system determines that for a query regarding “storage space,” the most effective input tool is an image upload tool (e.g., “Use photos to find storage . . . ”).

This determination is performed by a machine-learned model (e.g., an LLM) that analyzes the user query to select an input tool from a plurality of available tools, such as image upload, video upload, multiple-choice questions (Q&A), or visual inspiration selectors. For example, if the user query relates to a visual product like a rug, the model may select an image upload tool to analyze the user's room; conversely, if the query relates to a service like a credit card, the model may select a Q&A tool.

Once the input tool is selected, the system receives additional information uploaded by the user via the input tool. The input parsing module 110 processes this additional information to generate a description or context. For instance, in a storage use case, the model focuses on creating an inventory of movable items from an uploaded image, whereas for a furniture use case, the model focuses on aesthetics and style.

The flow continues to the offer matching module 120. This module processes the user query and the refined additional information to select a content item (e.g., a product or service offer) associated with a content provider. As indicated in FIG. 1, this selection is subject to “Advertiser Control,” meaning the system filters and ranks recommendations based on the content provider's business objectives and available inventory.

Finally, the system presents the selected content item on a graphical user interface. This presentation includes “Rich Explanations and Visualization Features” to aid in confident decision-making. For example, the system may generate a brief explanation of why the specific content item was selected based on the analysis of the user's uploaded information (e.g., explaining that a specific storage unit fits the volume of items detected in the user's photo).

Additionally, the input parsing module 110 can include an assisted modalities. The assisted modalities can consist of set of pre-built tools to collect user input and further refine user intent. For a given user query, the agent can select which input tool can help users to best articulate their complex needs. The agent can select a tool type based on user intent and/or query. For example, a question-and-answer tool can be selected if a user is searching for a credit card, whereas a video upload tool can be selected if the user is trying to find the ideal storage unit size.

In some instances, the content provider can specify one or more tools to be used for a given campaign. For some embodiments, the system or the content provider can select more than one tool (e.g., primary and secondary modality). For example, for choosing the best living room rug, a user could either upload the image of their living room or select one of the visual inspiration categories.

In some instances, the system can have a multi-turn modality. For example, the system can post the first set of recommendations, then trigger another relevant modality to help users further narrow down their choices.

The set of tools can include image upload, multiple choice questions, video upload, and/or visual inspiration. For example, with the visual inspiration tool, the system can provide a plurality of inspiration categories to select from.

Instructions can vary based on the selected input tool and/or the user query. For example, with an image upload tool, the agent can focus on what kind of image can provide the best output and how the uploaded image can help user get a recommendation. For the question-and-answer tool, the system can optimize presenting as few questions as possible to get a better understanding of user needs.

Input description can summarize relevant context from user input. For example, for the same user input (e.g., upload image of their living room), generated description will vary based on user query. For example, for the moving or storage use cases, LLM can focus on creating an inventory of movable items. Whereas for houseware/rugs use case, LLM can focus on aesthetics, style of living room which is more relevant for rugs selection.

The output can include object classification. For example, the system can call out specific objects with relevant attributes (e.g., counts, prices).

In some instances, the agent is able to learn from past interactions and build a user profile over time (limited to interaction with a given content provider). For example, from images uploaded for storage use cases, agents can learn the aesthetics of users'living rooms. Later when the user searches for rugs etc., agents can use the learnt aesthetics as context for the new conversation.

The offer matching module 120 can be responsible for matching relevant products based on refined user input. Based on user query, input description, and content provider input, the offer matching model can recommend a set of content items relevant to the user. The set of content items can be in a single or multiple categories. The system can recommend different categories of offers to users including options to cross-sell additional products and/or services. For example, for a ‘best LED TVs’ query, in addition to TV, a content provider can additionally recommend Installation services and/or warranty options.

The system can have various ways to access the offer feed. In one example, the system can access the offer feed using the existing search engine feed. In another example, the search engine can crawl the offer feed directly from the landing page. In yet another example, content providers can provide the offer feed via API access. The system can additionally enrich the shown offers with various other features to improve user comprehension and decision making. The recommended offer can have a brief explanation of why the offer is the right product for the user, which can be important to gain user trust and confidence.

In some instances, the user can visualize a recommended product in their own context. For example, the recommended rug can be visualized in the room based on an image uploaded by the user.

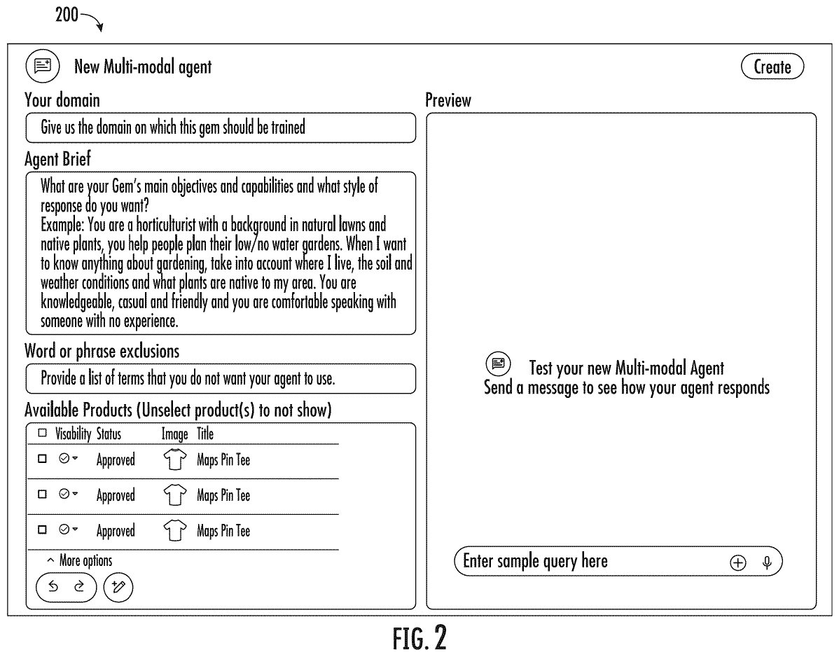

Referring now to FIG. 2, an exemplary graphical user interface 200 of a system in accordance with embodiments of the present disclosure. FIG. 2 illustrates a user interface with basic controls for the content provider to fine tune agents built by the system.

FIG. 2 is an exemplary graphical user interface 200 of a system in accordance with embodiments of the present disclosure. This interface represents a “self-serve” configuration tool that allows a content provider (e.g., an advertiser) to generate and customize a multi-modal AI agent without requiring direct software development or coding.

The interface 200 includes a configuration panel (left side) and a simulation or preview panel (right side). The configuration panel allows the content provider to input high-level logic and constraints for the agent. Key input fields include:
Your Domain: A field where the provider inputs the specific website or business domain on which the agent should be trained.
Agent Brief: A text input area where the provider defines the agent's main objectives, capabilities, persona or style. As shown in the example, a user can define the agent as a “horticulturist” that is “knowledgeable, casual and friendly.” The system uses this unstructured text to programmatically generate the system instructions (or “system prompt”) for the runtime model.
Word or Phrase Exclusions: A control allowing the provider to list specific terms or competitor names that the agent is strictly prohibited from using during a conversation.
Available Products: A selection tool (e.g., a list with checkboxes) where the provider can manually include or exclude specific products or inventory items from being recommended by the agent.

The preview panel on the right allows the content provider to immediately test the generated agent by entering a sample query (e.g., “Enter sample query here”). This simulation renders the agent's responses in real-time, allowing the provider to verify the “voice” of the agent and ensure it adheres to the defined exclusions before deploying it to a live environment.

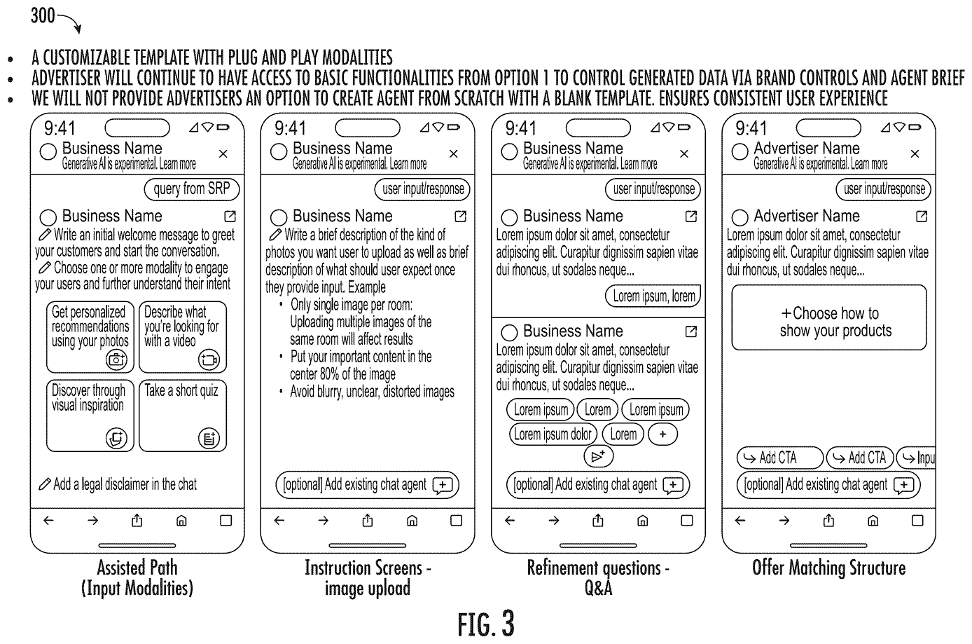

Referring now to FIG. 3, an exemplary graphical user interface 300 of a system in accordance with embodiments of the present disclosure. FIG. 3 illustrates a user interface with advanced controls where the content provider builds agents screen by screen.

FIG. 3 is an exemplary embodiment of a graphical user interface 300 of a system in accordance with embodiments of the present disclosure, illustrating an “advanced” control mode. Unlike the high-level interface of FIG. 2, the interface 300 provides a customizable template with plug-and-play modalities, giving the content provider granular control over specific interaction screens.

In this embodiment, the content provider can explicitly configure the conversation flow screen-by-screen with:
Welcome Message Configuration: The provider can edit the initial greeting text to set the tone of the conversation.
Modality Selection: The interface allows the provider to choose one or more specific input tools (modalities) that the agent is permitted to offer to a user. Options illustrated include “Get personalized recommendations using your photos” (Image Upload), “Describe what you're looking for with a video” (Video Upload), “Discover through visual inspiration” (Selection), or “Take a short quiz” (Q&A).
Instruction Screens: Once a modality is selected, the provider can customize the instructions presented to the user. For example, for an image upload tool, the provider can specify “Photo uploading tips,” such as instructing the user to “Put your important content in the center 80% of the image.” The system ensures a consistent user experience by not providing a blank slate, but rather, it enforces an “Offer Matching Structure” where the provider modifies existing templates (e.g., “Limited user edit controls”) to ensure the generated agent remains functional and high-quality while reflecting the specific branding and inventory of the business.

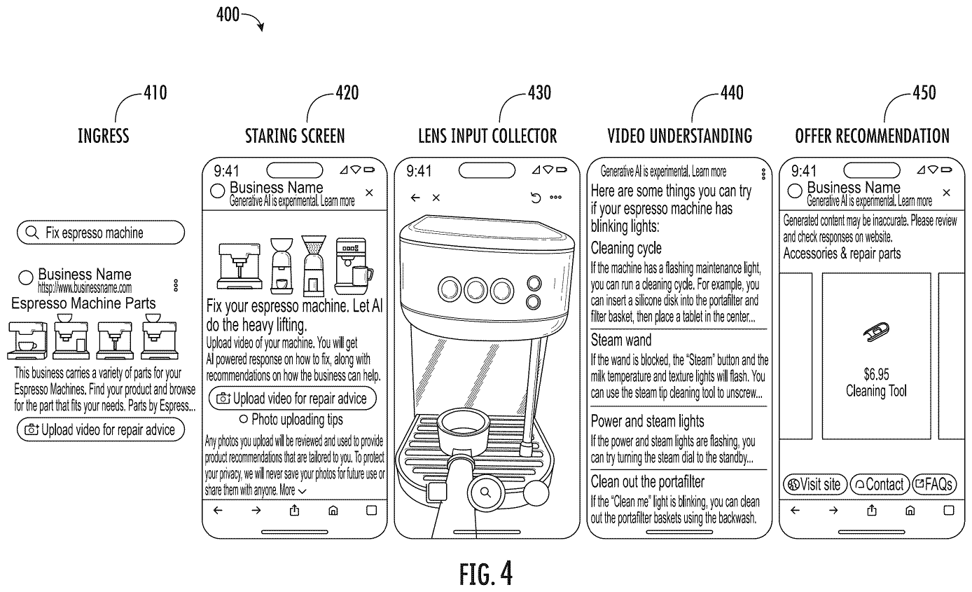

Referring now to FIG. 4, an exemplary diagram 400 of a user case in accordance with embodiments of the present disclosure. The diagram 400 can include an ingress 410 operation, a starting screen operation 420, a lens input collector operation 430, a visual understanding operation 440, and an offer recommendation operation.

FIG. 4 is an exemplary diagram 400 of a use case in accordance with embodiments of the present disclosure, specifically illustrating a “Video Repair” scenario. The diagram 400 demonstrates the sequential processing stages performed by the system: an ingress operation 410, a starting screen operation 420, a lens input collector operation 430, a video understanding operation 440, and an offer recommendation operation 450.

The process initiates at the ingress operation 410, where the system receives a user query from a client device. In this example, the user submits a text query “Fix espresso machine” via a search interface. Based on this specific query, the machine-learned model identifies that the user's intent is diagnostic and determines that a video input tool is the most appropriate modality.

Consequently, at the starting screen operation 420, the system presents the selected input tool to the user. The interface displays a call to action: “Fix your espresso machine. Let AI do the heavy lifting,” and explicitly prompts the user to “Upload video of your machine.” This step corresponds to the system determining an input tool (a video uploader) based on the user query (repair advice).

Next, at the lens input collector operation 430, the system receives additional information from the client device. The user utilizes the camera (lens) of the client device to capture a video or image of the specific appliance (the espresso machine). This additional information serves as the ground truth data for the subsequent analysis.

At the video understanding operation 440, the system performs processing of the additional information using the machine-learned model. The model analyzes the visual data to identify specific symptoms or states of the object. As illustrated, the system detects that the espresso machine has “blinking lights” and distinguishes between different error patterns, such as a “Cleaning cycle,” a blocked “Steam wand,” or “Power and steam lights”. Specifically, the system identifies that the “Clean me” light is blinking, which correlates to a specific maintenance need (cleaning out the portafilter baskets).

Finally, at the offer recommendation operation 450, the system presents a content item on the graphical user interface. Based on the specific diagnosis (the “Clean me” light), the system selects a relevant product associated with the content provider-in this case, a “$6.95 Cleaning Tool”. This recommendation is presented alongside a rich explanation (“If the ‘Clean me’ light is blinking . . . ”) to validate the suggestion. The interface facilitates the transaction by providing a link to “Visit site” or “Contact” the business.

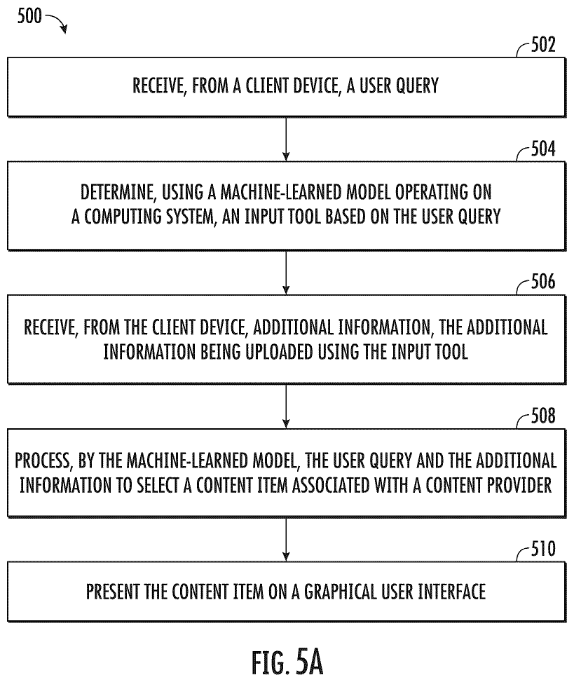

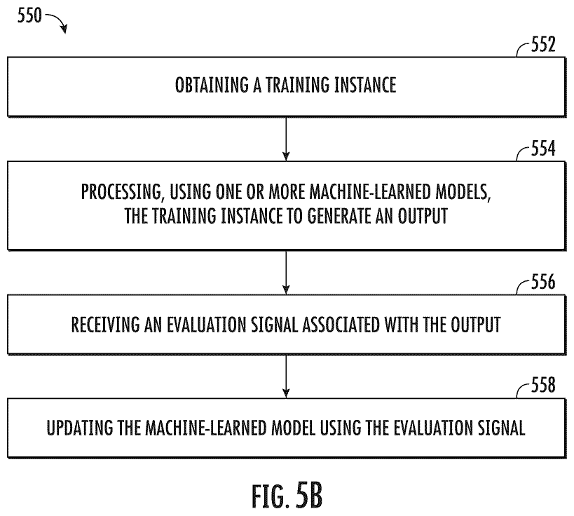

Referring now to FIG. 5A, a flowchart of a method 500 for the generation of a recommendation using a large language model. One or more portion(s) of example method 500 can be implemented by a computing system that includes one or more computing devices such as, for example, computing systems described with reference to FIGS. 1-9. Each respective portion of example method 500 can be performed by any (or any combination) of one or more computing devices. Moreover, one or more portion(s) of example method 500 can be implemented on the hardware components of the device(s) described herein, for example, to train one or more systems or models. FIG. 5A depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5A is described with reference to elements/terms described with respect to other systems and figures for exemplary illustrated purposes and is not meant to be limiting. One or more portions of example method 550 can be performed additionally, or alternatively, by other systems.

At operation 502, the method includes receiving, from a client device, a user query. In some instances, the user query is a multimodal input. The user query can be a text string entered into a search bar, a voice command, or a multimodal input (e.g., text combined with an initial image).

At operation 504, the method can include determining, using a machine-learned model operating on a computing system, an input tool based on the user query. The machine-learned model analyzes the intent behind the user query to select the most appropriate modality for gathering further information. In some embodiments, the input tool is an image uploading tool (e.g., for furniture or decor queries). In other embodiments, the input tool is a video uploading tool (e.g., for repair or diagnostic queries). Alternatively, the input tool may be a multiple-choice question interface (e.g., for financial or service-based queries) or a visual inspiration tool. In some instances, the determination of the input tool is further based on a preference configuration set by the content provider (e.g., via the interface shown in FIG. 3).

In some instances, the machine-learned model is a plug-in on a web browser.

In some instances, the input tool is an image uploading tool.

In some instances, the input tool is a video uploading tool.

In some instances, the input tool is a multiple choice question.

In some instances, the input tool is a visual inspiration tool.

In some instances, the input tool is further determined based on a preference by the content provider.

At operation 506, the method can include receiving, from the client device, additional information, the additional information being uploaded using the input tool. For example, this may include an image file of a living room, a video file of a malfunctioning appliance, or a set of answers to a quiz.

At operation 508, the method can include processing, by the machine-learned model, the user query and the additional information to select a content item associated with a content provider. The content item (e.g., a product listing or service offer) may be directly provided by the content provider via an API or obtained by the computing system crawling a webpage of the content provider. In some embodiments, this processing step further involves accessing historical user query data or query context data to refine the selection.

In some instances, the content item is provided by the content provider.

In some instances, the content item is obtained by the computing system from a webpage of the content provider.

At operation 510, the method can include presenting the content item on a graphical user interface. This presentation may include the content item itself (e.g., a “Cleaning Tool”) alongside rich explanations derived from the processing of the additional information. In further embodiments, the method may include receiving a user response associated with the presented content item and processing that response to generate an updated content item, thereby facilitating a multi-turn conversation.

In some instances, the method can further include accessing historical user query data. Additionally, the method can include processing, by the machine-learned model, the user query, the additional information, and the historical user query data to select the content item.

In some instances, the method can further include accessing query context data. Additionally, the method can include processing, by the machine-learned model, the user query, the additional information, and the query context data to select the content item.

In some instances, the method can include receiving a user response associated with the content item. Additionally, the method can include processing, by the LLM, the user response, the multimodal input data, the user query data, and the query context data to generate an updated content item.

FIG. 5B depicts a flowchart of a method 550 for training one or more machine-learned models according to aspects of the present disclosure. One or more portion(s) of example method 550 can be implemented by a computing system that includes one or more computing devices such as, for example, computing systems described with reference to FIGS. 1-9. Each respective portion of example method 550 can be performed by any (or any combination) of one or more computing devices. Moreover, one or more portion(s) of example method 550 can be implemented on the hardware components of the device(s) described herein, for example, to train one or more systems or models. FIG. 5B depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5B is described with reference to elements/terms described with respect to other systems and figures for exemplary illustrated purposes and is not meant to be limiting. One or more portions of example method 550 can be performed additionally, or alternatively, by other systems.

At 552, example method 550 can include obtaining a training instance. A set of training data can include a plurality of training instances divided between multiple datasets (e.g., a training dataset, a validation dataset, or testing dataset). A training instance can be labeled or unlabeled. Although referred to in example method 550 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 554, example method 550 can include processing, using one or more machine-learned models, the training instance to generate an output. The output can be directly obtained from the one or more machine-learned models or can be a downstream result of a chain of processing operations that includes an output of the one or more machine-learned models.

At 556, example method 550 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-supervised or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 558, example method 550 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 550 can include implementing a number of generalization techniques (e.g., weight decays, dropouts, etc.) to improve the generalization capability of the models being trained.

In some implementations, example method 550 can be implemented for training a machine-learned model from an initialized state to a fully trained state (e.g., when the model exhibits a desired performance profile, such as based on accuracy, precision, recall, etc.).

In some implementations, example method 550 can be implemented for particular stages of a training procedure. For instance, in some implementations, example method 500 can be implemented for pre-training a machine-learned model. Pre-training can include, for instance, large-scale training over potentially noisy data to achieve a broad base of performance levels across a variety of tasks/data types.

In some implementations, example method 550 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 550 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 550 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

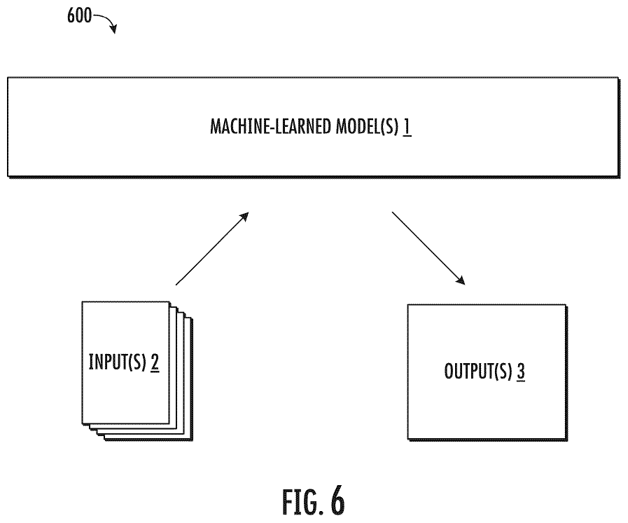

FIG. 6 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree-based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of LLM 106 and/or any other machine-learning model mentioned herein.

Although various features, variations, and implementations described below are described with respect to machine-learned model(s) 1, it is to be understood that such features, variations, and implementations are to be understood as described with respect to LLM 106 and/or any other machine-learning model mentioned herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single, or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully connected layers).

Machine-learned model(s) 1 can employ a mixture-of-experts structure. See, e.g., Zhou et al., Mixture-of-Experts with Expert Choice Routing, ARXIV: 2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing the quantity of operations performed for processing a given input compared to a densely activated model. In this manner, for instance, the expressive and interpretive power of a high-parameter-count model can be achieved with more computationally efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

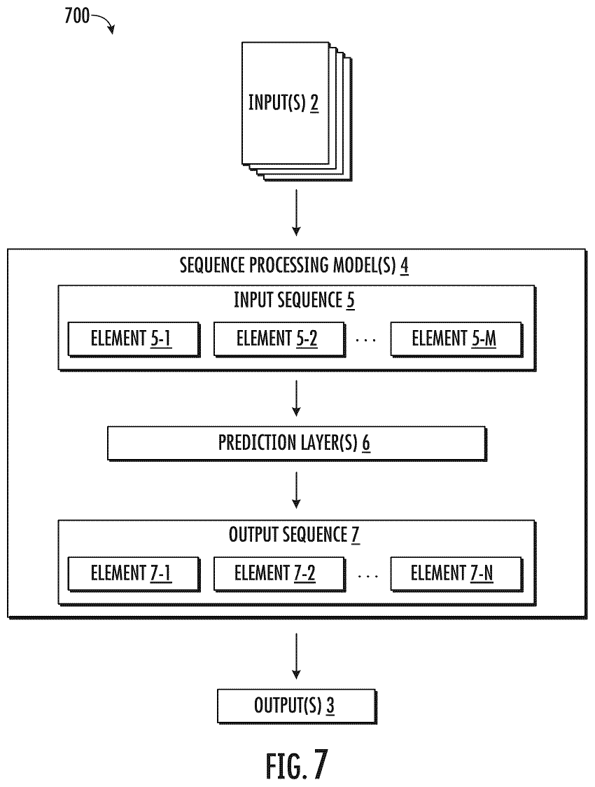

FIG. 7 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of _______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.” A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

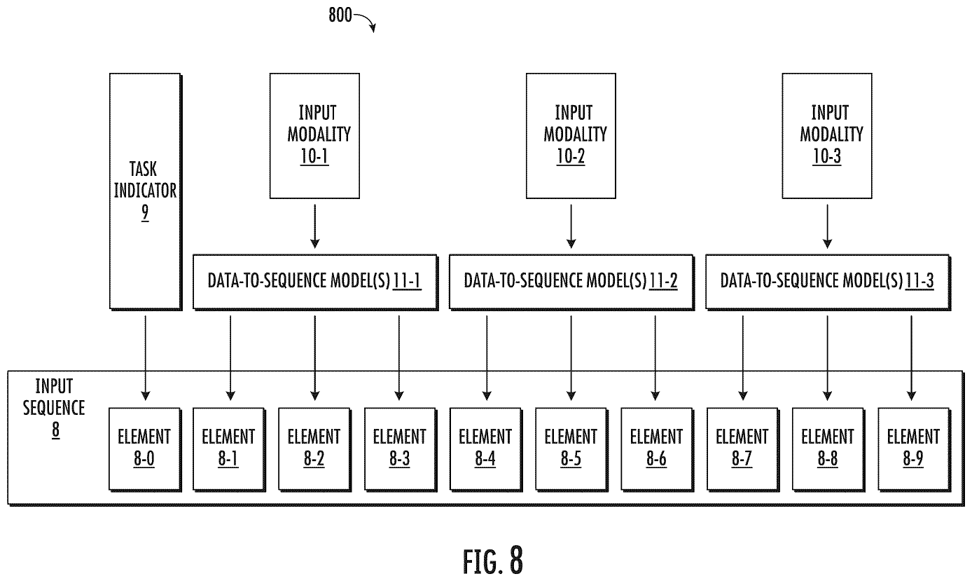

FIG. 8 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

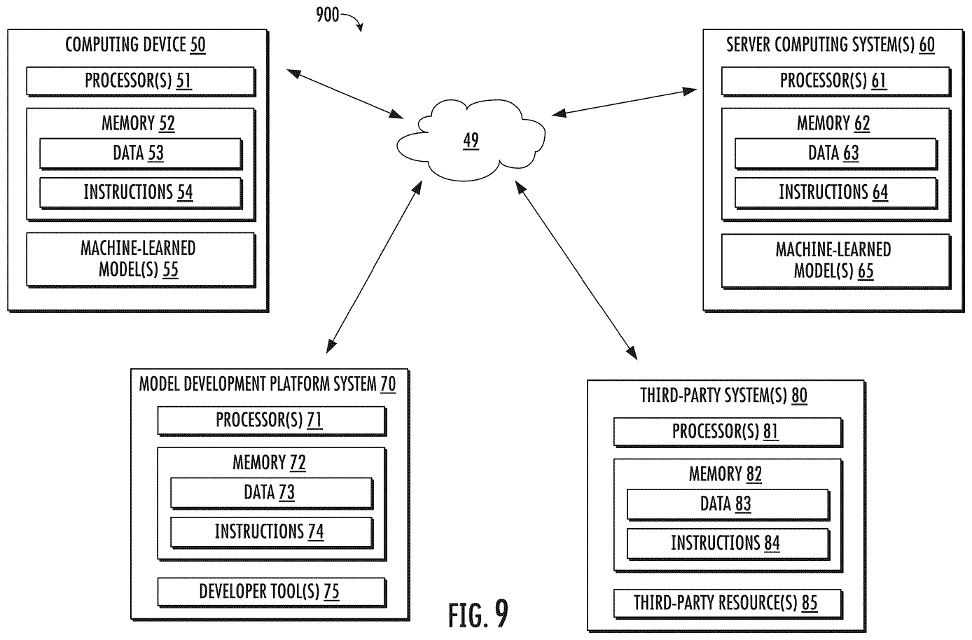

FIG. 9 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 9 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 9 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of,” “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

1. A computer-implemented method, comprising:
receiving, from a client device, a user query;
determining, using a machine-learned model operating on a computing system, an input tool from a plurality of input tools based on the user query;
receiving, from the client device, additional information, the additional information being uploaded using the input tool;
processing, by the machine-learned model, the user query and the additional information to select a content item associated with a content provider; and
presenting the content item on a graphical user interface.

2. The computer-implemented method of claim 1, wherein the input tool is an image uploading tool.

3. The computer-implemented method of claim 2, wherein the content item is presented in an image that has been uploaded by the client device using the image uploading tool.

4. The computer-implemented method of claim 1, wherein the input tool is a video uploading tool.

5. The computer-implemented method of claim 1, wherein the input tool is a multiple choice question.

6. The computer-implemented method of claim 1, wherein the input tool is a visual inspiration tool.

7. The computer-implemented method of claim 1, wherein the input tool is further determined based on a preference by the content provider.

8. The computer-implemented method of claim 1, wherein the content item is provided by the content provider.

9. The computer-implemented method of claim 1, wherein the content item is obtained by the computing system from a webpage of the content provider.

10. The computer-implemented method of claim 1, wherein the user query is a multimodal input.

11. The computer-implemented method of claim 1, further comprising:
accessing historical user query data; and
processing, by the machine-learned model, the user query, the additional information, and the historical user query data to select the content item.

12. The computer-implemented method of claim 1, further comprising:
receiving content provider input from the content provider; and
processing, by the machine-learned model, the user query, the additional information, and the content provider input to select the content item.

13. The computer-implemented method of claim 1, further comprises:
receiving a user response associated with the content item; and
processing, by the machine-learned model, the user response, the multimodal input data, the user query data, and the query context data to generate an updated content item.

14. The computer-implemented method of claim 1, wherein the machine-learned model is a plug-in on a web browser.

15. The computer-implemented method of claim 1, wherein the machine-learned model is an artificial intelligence (AI) agent that exists as a URL.

16. The computer-implemented method of claim 15, wherein the URL can be shared by the client device of a first user to a second client device of a second user.

17. The computer-implemented method of claim 15, wherein the content provider directly links the AI agent to a website associated with the content provider.

18. The computer-implemented method of claim 1, wherein the machine-learned model is an artificial intelligence (AI) agent plug-in that is accessible from a website associated with a content provider.

19. One or more non-transitory, computer readable media storing instructions that are executable by one or more processors to cause a computing system to perform operations, the operations comprising the method of claim 1.

20. A computing system, comprising:
one or more processors; and
one or more transitory or non-transitory computer-readable media storing instructions that are executable to cause the one or more processors to perform operations, the operations comprising:
receiving, from a client device, a user query;
determining, using a machine-learned model operating on a computing system, an input tool based on the user query;
receiving, from the client device, additional information, the additional information being uploaded using the input tool;
processing, by the machine-learned model, the user query and the additional information to select a content item associated with a content provider; and
presenting the content item on a graphical user interface.
